(19) United States
(12) Patent Application Publication
(10) Pub. No.: US 2006/0080206 A1
(43) Pub. Date: Apr. 13, 2006

(54) Integrated strategic business planning process (ISBPP) business method

(76) Inventors: William R. Herren, Saginaw, MI (US); Rudy Wilson, Birmingham, MI (US)

Correspondence Address: ASIA DEVELOPMENT CAPITAL LLC, 401 SOUTH OLD WOODWARD, SUITE 450, BIRMINGHAM, MI, 48009, US

(21) Appl. No.: 11/248,712

(22) Filed: Oct. 12, 2005

Related U.S. Application Data
(60) Provisional application No. 60/617,495, filed on Oct. 12, 2004.

(51) Int. Cl. G06Q 40/00

(52) U.S. Cl. 705/35

(57) ABSTRACT

Various embodiments of the invention include a financial and operations business planning process to provide a balanced and integrated operating plan for an automotive supplier firm. One embodiment includes a “Free Flow” Marketing Plan, several functional plans, and a financial plan. The executive management team sanctions and institutionalize the process within its individual business line. Individual functional manager provide the required plan detail to balance and integrate with other functional plans.

### BACKGROUND

Automotive component manufacturing companies (“Suppliers”) due to the inherent nature of their industry operate in a business climate known as a “buyer's oligopsony” where a small group of large automotive vehicle assemblers (“Buyers”) control a large proportion of the market. Globally there are over 9,000 individual Suppliers and around 30 Buyers (independent and global purchasing organizations encompassing affiliates). This type of market is characterized by Buyers driving down prices for both commodity and differentiated automotive components. Additionally Buyers maintain a dominate position in demanding non-price supply contract terms and conditions including unilateral use of Supplier intellectual property, right to audit manufacturing processes, ownership of process tooling and automatic resourcing in the event a lower contract price can be found from another Supplier.

Therefore Suppliers must have a business model that can not only achieve but also sustain a competitive advantage in the market place, anticipate actions by its competitors and be able to monitor investments in foreign environments while meeting the following key financial metrics:
Increasing gross margins
Maintaining stable Selling, General and Administrative (SGA) expenses relative to revenues
Increasing free cash flows

The Integrated Strategic Business Planning Process (ISBPP) is developed specifically for Suppliers to systematically analyze their business models and modify where necessary their individual operating components to achieve an integrated and balanced plan. An integrated and balanced plan leads to a reduction in operating costs and a normalizing of revenues taking into consideration pricing and volume variables which characteristically have a major impact on Supplier operating performance.

The keys to this Process are the iterative loops shown on the attached flow diagram. If the individual functional plans are not able to be integrated, the marketing opportunities must be revised. This iteration continues until the functional plans are sufficiently integrated. Once the plans are integrated the financial plan will show whether the strategic plan is balanced (i.e. financial metrics are met and there are sufficient resources (time, people and money) available. If the metrics are not met or there are not sufficient resources available, the marketing opportunities must be revisited. This iteration continues until the plan is balanced.

### DETAILED DESCRIPTION

Embodiments of the invention, described below, provide a system of providing enhanced financial and operations management, such as in the automotive supplier industry.

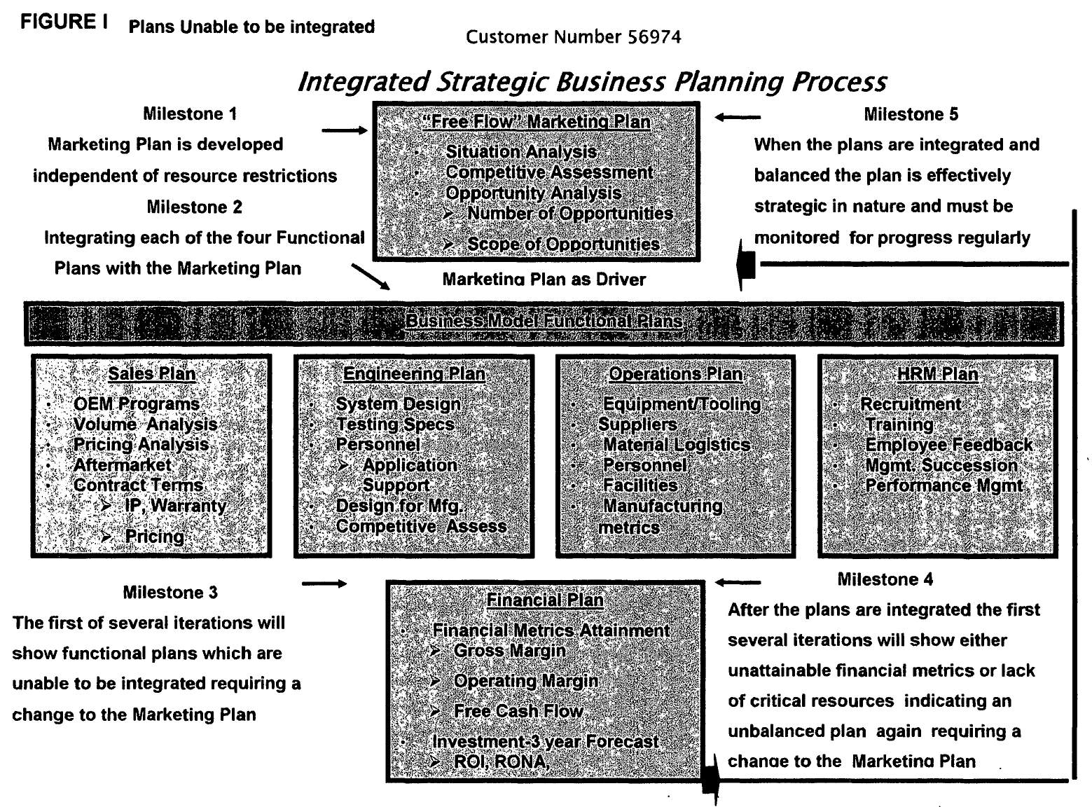

FIG. 1 is a block diagram illustrating the overall Integrated Strategic Business Planning Process. The Process includes a Free Flow Marketing Plan, four functional plans depending upon how a supplier firm is organized, a financial plan and five milestones within an iterative loop. The marketing manager is the driver or starting point for the process and the information is provided without regard to resource requirements or referred to as “Free Flow”. The executive management team will sanction the development of the marketing plan independent of the business.

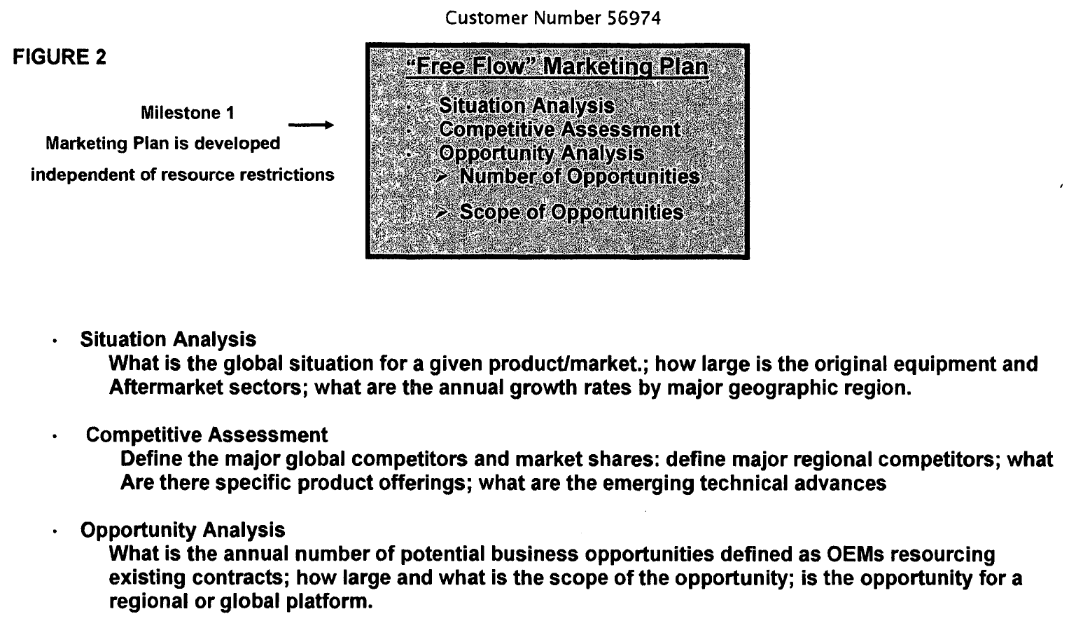

FIG. 2 is a block diagram illustrating the specific parts of a “Free Flow” Marketing Plan. The plan is designed and analyzed for a specific product/market applications and as a result traditional volume analysis is not employed. Instead the volume level is analyzed in context with the actions of the global and regional competitors and the business sourcing opportunities available.

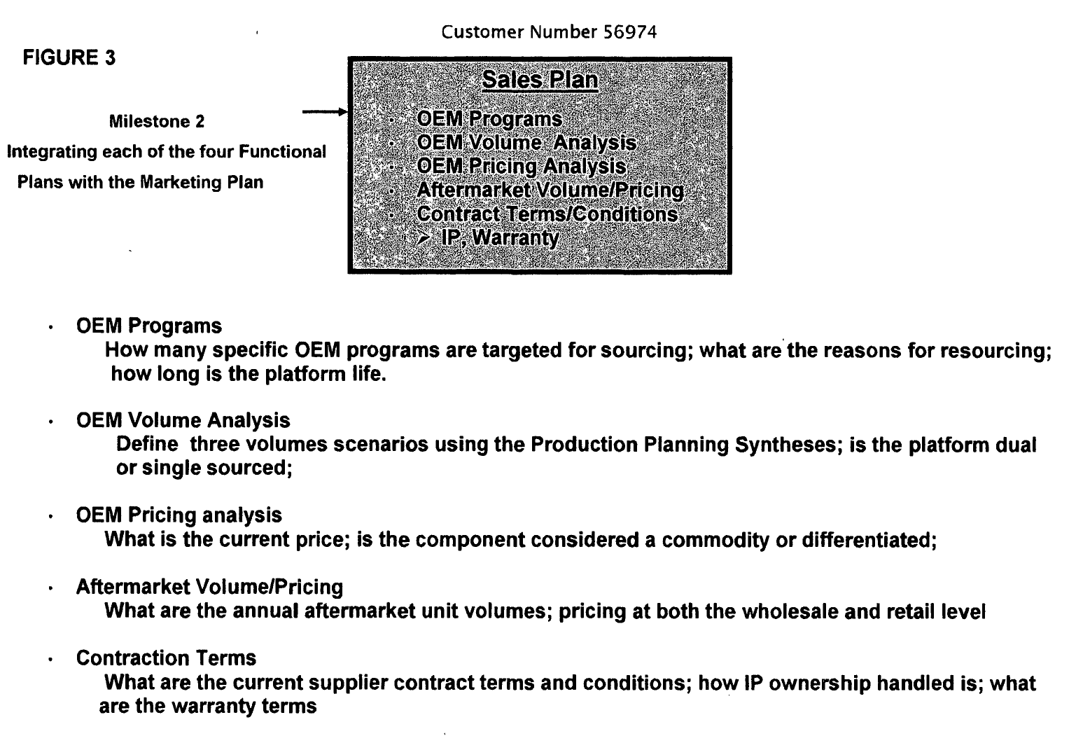

FIG. 3 is a block diagram illustrating the specific parts of a Sales Plan. The plan is designed to analyze in detail what the specific opportunists are, including pricing and contract terms and conditions. The aftermarket is analyzed separately to review volumes and pricing at the retail and wholesale levels. An overall sales plan is developed as a result.

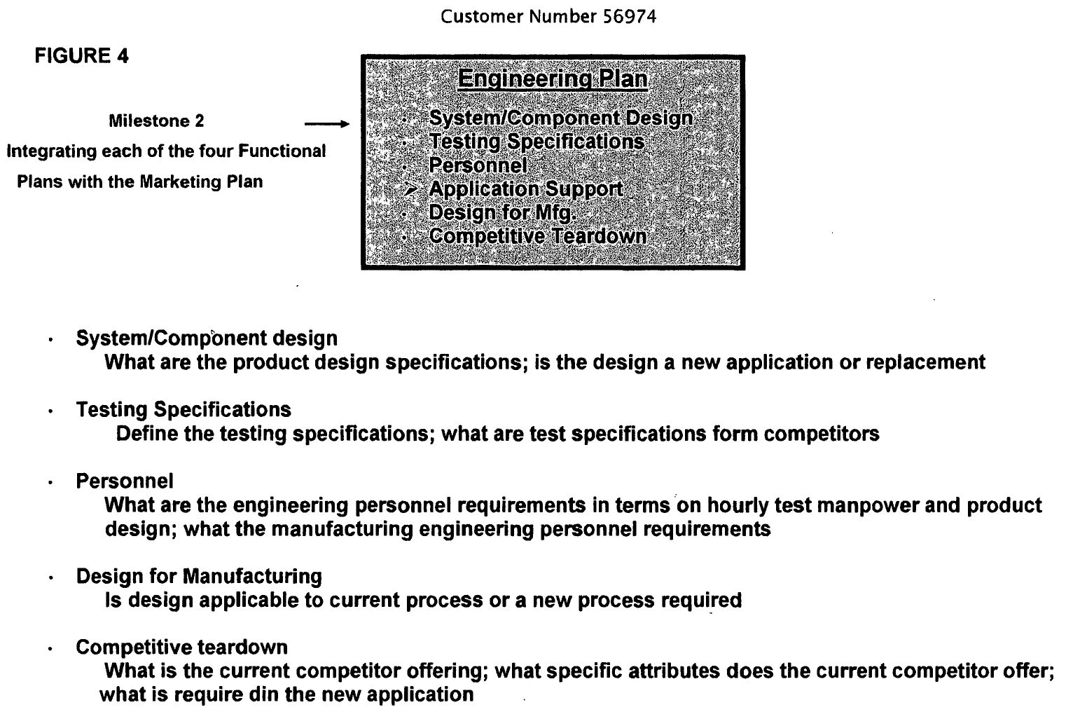

FIG. 4 is a block diagram illustrating the specific parts of an Engineering Plan. The plan is designed to analyze how a business opportunity application product is designed and manufactured to compete with the latest product offerings. Engineering personnel allocation levels are examined to determine staffing requirements. Processing of the component is taken into account along with the investment the capital to build new equipment and tooling.

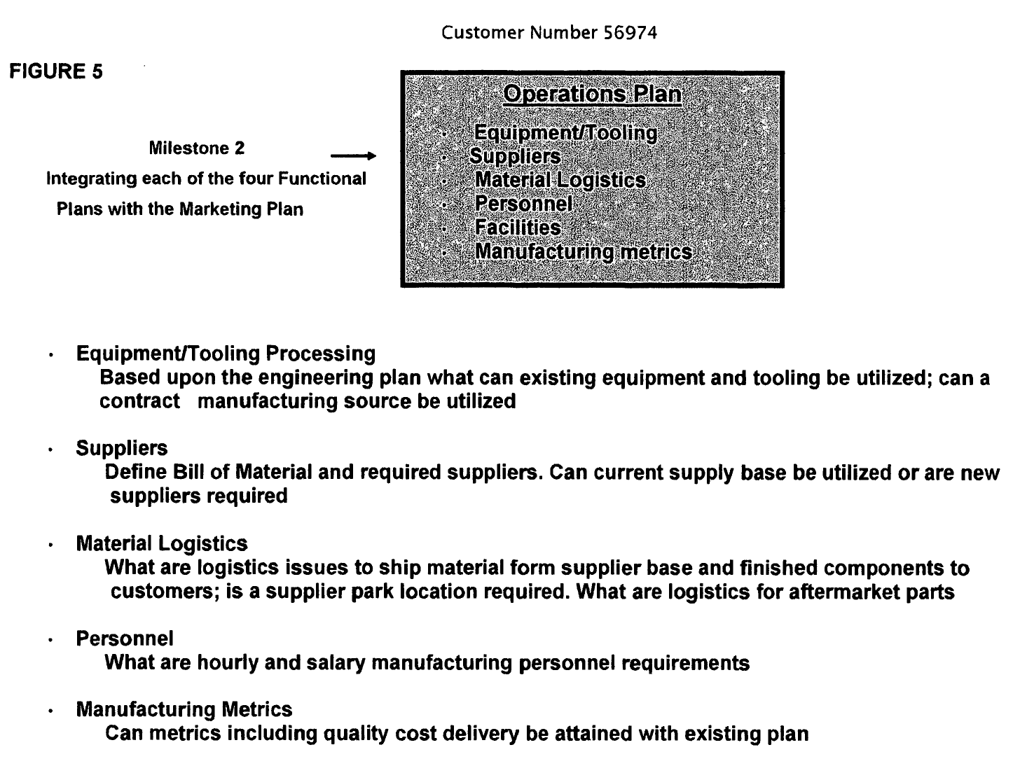

FIG. 5 is a block diagram illustrating the specific parts of an Operations Plan. The plan is designed to integrate the component processing into the current facilities and to plan for the allocation of personnel to manufacture the parts

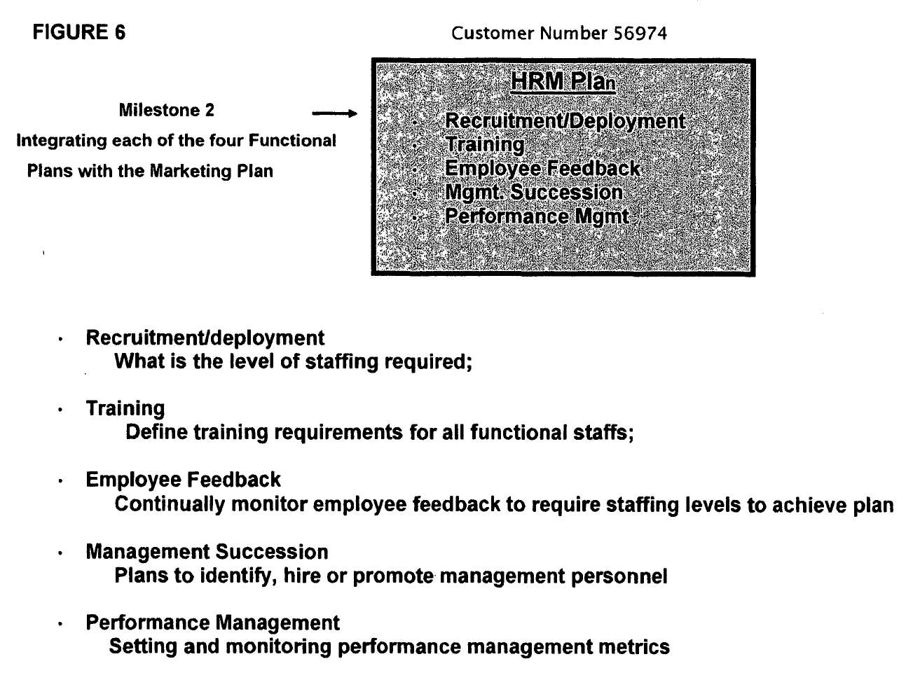

FIG. 6 is a block diagram illustrating the specific parts of a Human Resources Plan. The plan encompasses all personnel requirements dictated by the marketing, sales, engineering and operations plans and taking into consideration the required training.

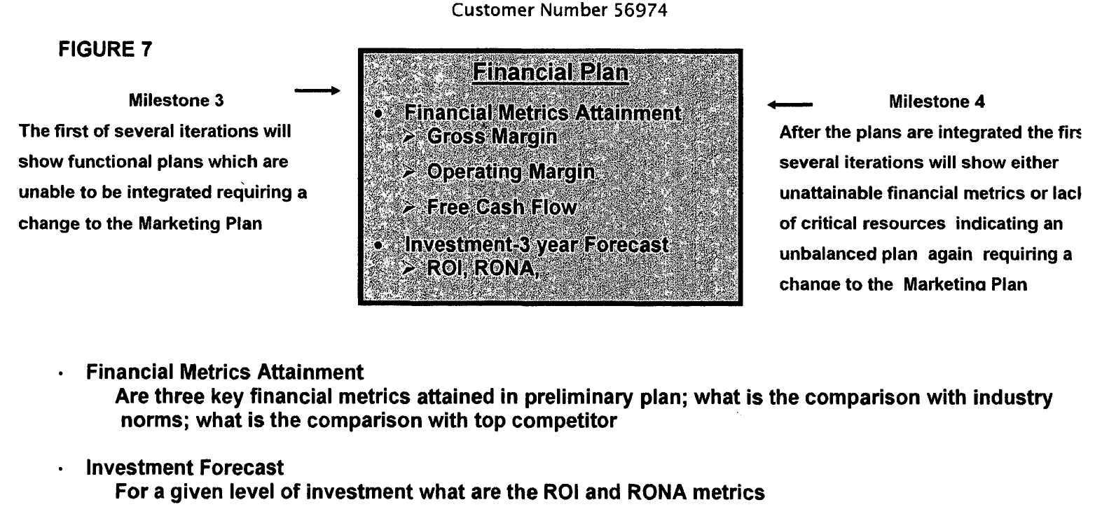

FIG. 7 is a block diagram illustrating the specific parts of a Financial Plan. The plan is a direct by-product of the individual functional plans and industry and “best in line” competitors operating metrics

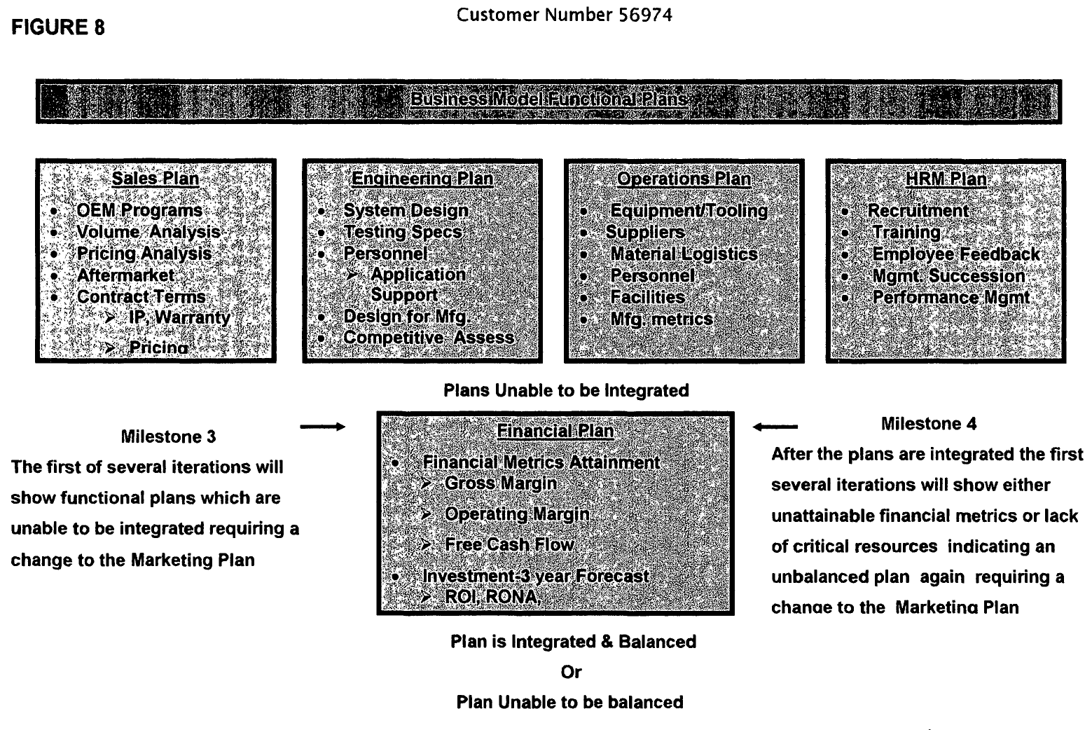

FIG. 8 is a block diagram illustrating the specific parts involving the integration and balancing of functional plans and the resulting financial plan. The plan necessarily goes through several iterative steps to first integrate and then balance the overall plan. The financial metrics are analyzed for attainment.

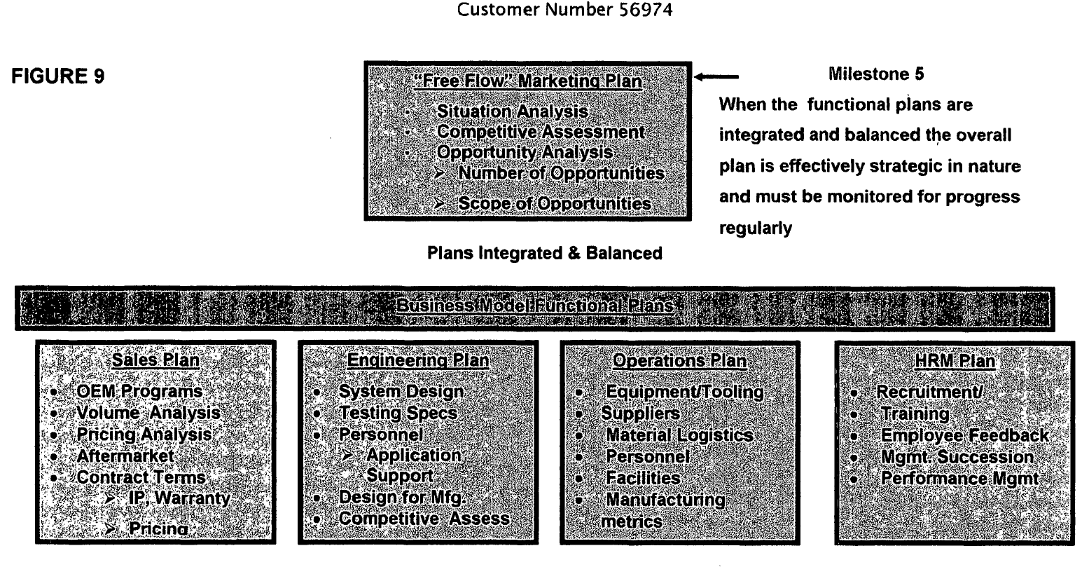

FIG. 9 is a block diagram illustrating the Overall ISBPP iterative process. The Marketing Plan is either adjusted to balance the overall plan or management signifies that the specified resources are available and allocates accordingly to the business signifying that the Business Plan is strategic and thus approved by management

What is claimed is:

1. An operations and financial business planning process system for a manufacturing business entity in the automotive industry, the system comprising:
A detailed business planning process;
A global “Free Flow” marketing plan permitting a business's executive management team to assess and analyze its markets continually including an global situation, competitive assessment and business opportunity analysis;
Detailed business functional plan analysis permitting a business to systematically plan and integrate its various business functions;
Wherein the process is configured for personal interaction between the each functional manager and the manager of marketing to allow for a complete understanding of the “Free Flow” marketing plan and its various facets.
Wherein each functional manager provides his/her its own operating budget
Wherein each functional manager interacts to eliminate expenses cause by overlapping actions, resource commitments not covered in the “Free Flow” marketing plan
Wherein functional group assess the actions necessary to carry out the “Free Flow marketing plan
Wherein the plan is integrated and a preliminary financial plan is analyzed to determine whether pre-determined financial metrics can be attained
Wherein the executive management team assess whether key resource are available to carry out the plan;
Wherein several or more iterative lops are conducted before executive management assigns resources to carry out the overall plan.
